(19) United States
(12) Patent Application Publication
(10) Pub. No.: US 2017/0297750 A1
(43) Pub. Date: Oct. 19, 2017

(54) Radiative Cooling Panels For Spacecraft

(71) Applicant: Palo Alto Research Center Incorporated, Palo Alto, CA (US)

(72) Inventors: Victor Liu, Mountain Veiw, CA (US); Bernard D. Casse, Saratoga, CA (US); George Daniel, Palo Alto, CA (US); Farzaneh Afshinmanesh, Menlo Park, CA (US)

(73) Assignee: Palo Alto Research Center Incorporated

(21) Appl. No.: 15/132,948

(22) Filed: Apr. 19, 2016

(51) Int. Cl. B64G 1/50

(52) U.S. Cl. CPC B64G 1/503

(57) ABSTRACT

A self-adjusting passive radiative cooling panel for spacecraft including a dielectric (e.g., HfO₂) layer sandwiched between a mirror layer and spaced-apart thin-film phase-change (e.g., thermochromic) material islands disposed in a grating pattern having a lattice constant in the 2 to 10 μm range, depending on expected spacecraft operating temperatures. At low temperatures the phase-change material islands enter dielectric state phases that prevent generation of guided modes in the dielectric layer resulting in zero or low mid-IR emission. At high temperatures the phase-change material islands enter a metal state phase that couples mid-IR (thermal) radiation to guided mode resonances resulting in high mid-IR emission. The thermal emission can be tuned by the lattice constant of the grating pattern to peak at a target mid-IR wavelength (e.g., 8 μm), thereby significantly increasing the thermal emission contrast between the low and high temperature states resulting in the minimization of system-wide thermal transients.

### FIELD OF THE INVENTION

This invention relates to cooling systems, and more particularly to self-adjusting passive radiative cooling systems for spacecraft.

### BACKGROUND OF THE INVENTION

Thermal regulation (temperature control) is a critical component of any highly integrated system, and generally involves adding thermal energy (heat) to the system when subjected to low temperatures such that the system is maintained above its minimum operating temperature, and removing heat from the system subjected to high temperatures such that the system is maintained below its maximum operating temperature. In general, the addition or removal of heat is achieved using one of three heat transfer mechanisms: conduction, convection (aka, diffusion) and radiation. Adding thermal energy to (heating) a system is typically achieved by way of actuating a resistive or other heating element disposed adjacent to the system, and utilizing conduction or convention to transfer heat generated by the heating element to the system. Removing heat from (cooling) a system is usually achieved by way of transferring heat from the system by way of conduction to a fluid coolant, which then transfers the heat by way conduction or convection to a remote heat sink.

On orbiting or otherwise extra-terrestrially deployed spacecraft, removing heat from (i.e., cooling) a given spacecraft's systems presents a far more difficult thermal regulation challenge than that typically encountered on earth. Because deployed spacecraft are surrounded by vacuum, both convection and conduction are not practical heat transfer (cooling) mechanisms, meaning that cooling the spacecraft must be entirely accomplished by way of radiating heat into space. Moreover, different spacecraft have vastly different thermal regulation requirements. For example, low earth orbit (LEO) satellites and geosynchronous (GEO) satellites have different solar exposures. Many satellites experience day/night cycles as they enter and exit the shadow of the earth, requiring dynamic adjustment of their thermal radiation over time. Additional practical concerns on spacecraft include system minimum/maximum operating temperature ranges, cost, weight, complexity, and robustness.

In general, heat removal from a system solely by way of radiation involves causing the system to emit thermal energy in the form of electromagnetic waves in the infrared region at a rate that exceeds the rate of thermal energy received by the system (e.g., the sum of incident radiant energy and resistive heat generated by operating system components). An object's ability to emit thermal energy is usually described with reference to a “black body”, which is a hypothetical body (object) that completely absorbs electromagnetic radiation at all wavelengths (i.e., none of the incident radiation is reflected, and therefore appears black at normal room temperatures), and emits thermal radiation at wavelength ranges determined by the blackbody's absolute temperature. The blackbody radiation spectrum, defining the upper limit of radiated power of objects at a given temperature, for typical semiconductor system/component operating temperature ranges, is peaked in the mid-IR wavelength range (i.e., approximately 7 μm (microns) to 13 μm). Using this blackbody reference, in order for an object to be a good thermal regulator for systems having typical temperature operating ranges, the object must be a good emitter/inhibitor of thermal radiation in the mid-IR wavelength range.

An early conventional approach for providing thermal regulation on a spacecraft involves covering significant portions of the spacecraft with multi-layer insulation (MLI). MLI is thermal insulation composed of multiple (e.g., 40 or more) layers of a thin sheet material (e.g., Kapton or Mylar) that are maintained in a spaced-apart relationship by extremely thin scrim or polyester ‘bridal veil’ separators. MLI's are often coated with a thicker outer layer (e.g., aluminum) that provides a shiny outer appearance. The multiple layers provide high thermal impedance between the sun (heat source) and the spacecraft protected environment, and therefore are effective at reducing satellite heating, but do little to promote cooling.

More recent satellite cooling technologies include using Optical Solar Reflectors (OSR's) and white pigments. OSR's include a quartz top layer disposed over a reflecting layer made of metal (e.g., silver). The quartz layer is a good emitter in the mid-IR and passes sunlight to the back silver mirror, which reflects sunlight back through the quartz layer and into space, resulting in a low absorption coefficient. The front surface of an OSR is typically coated in a conductive transparent oxide (like indium tin oxide) to prevent the buildup of surface charge. The optical characteristics of OSRs are not adjustable, and are brittle and dense. White thermal control paints (e.g., AZ-93, produced by AZ Technology of Huntsville, Ala., USA) are more primitive thermal radiators that have low solar absorptivity and high thermal emission in the mid-IR.

A metric by which satellite cooling technologies are evaluated is based on the mid-IR emissivity (∈) and its solar absorptivity (α). Typically, it is desired that the quotient α/∈ be minimized for a good thermal radiator. OSRs offer relatively low α/∈ ratio values of approximately 0.125. White pigments exhibit α/∈ ratio values of approximately 0.17, but make up for this relatively lower performance by being cheap, easy to apply, and very thin and lightweight.

A problem with the above-mentioned conventional satellite thermal regulator technologies is that they are based on static radiator technologies that preclude self-modulation of their associated optical and thermal properties. That is, in cold environments, there is no way to reduce the thermal radiation rate of MLI's or OSR's to conserve heat. In order to achieve this functionality, additional system complexity is required, for example mechanically rotatable vanes. However, this added complexity typically means higher probability of failure and additional system weight.

In view of the above, an idealized thermal regulating panel for spacecraft would exhibit dynamically thermal radiation properties such that the panel emits minimal amounts of thermal radiation at lower temperatures in order to maximize heat retention within the spacecraft, and emits significantly higher amounts of thermal radiation at higher temperatures in order to maximize heat emission from (i.e., cooling of) the spacecraft, with the transition between retention and emission coinciding with existing spacecraft system operating temperatures. In addition, the idealized thermal regulating panel would preferably achieve the desired dynamic adjustability using passive external stimuli (i.e., by detecting ambient temperatures or other parameters), as contrasted with requiring active control signals generated by a control system, in order to minimize system complexity and weight.

One approach currently being considered for achieving idealized self-adjusting passive radiative cooling panels utilizes thermochromic materials, which are a type of phase-change material having optical properties that change in response to changes in their temperature. To achieve the ideal cooling panel characteristics for spacecraft, such thermochromic materials would need to assume a high thermal radiation emission phase (i.e., an atomic configuration with optical properties that maximize emissions in the mid-IR wavelength range) at high temperatures, and would need to transition to a low thermal emission phase (i.e., a different atomic configuration with optical properties that minimize mid-IR emissions) at low temperatures. One thermochromic material that has shown promise for use in self-adjusting passive radiative panels is vanadium dioxide (VOz), which transitions from a semiconductor (dielectric) phase at low temperatures to a metal phase at higher temperatures (i.e., above about 66° C.). Moreover, the transition temperature at which VO₂ transforms from the dielectric state to metallic state is adjustable by way of including a suitable dopant into the VO₂ film using known techniques. For example, the transition temperature of a VO₂ film can be reduced to around 20° C. by way of doping with Tungsten (W), which conforms well with typical operating temperature ranges of most electrical systems. It is worth noting that bulk VO₂ films cannot be used directly to produce usable passive self-adjusting radiative cooling panels. The intrinsic property of bulk VO₂ is opposite to what is required for passive temperature stabilization applications; that is, bulk VO₂ is less emissive (more reflective) at higher temperatures than at colder temperatures. Thus, the challenge in utilizing VO₂ for producing self-adjusting thermal regulating panels is reversing this intrinsic property, which requires photonic engineering.

Various attempts have been made to produce passive self-adjusting thermal regulation panels for spacecraft that utilize VO₂. M. Benkahoul et al. disclosed smart radiator thin-film tiles including VO₂ films formed on silicon dioxide (SiO2) and aluminum (Al) (see “Multilayer Tunable Emittance Coatings, with Higher Emittance for Improved Smart Thermal Control in Space Applications”, 40th International Conference on Environmental Systems, Copyright © 2010 by the American Institute of Aeronautics and Astronautics, Inc.). M. Benkahoul et al. disclose depositing thermochromic VO₂ thin films on Al causes an increase in emissivity at higher temperatures (see “Thermochromic VO₂ film deposited on Al with tunable thermal emissivity for space applications”, Solar Energy Materials & Solar Cells 95 (2011) 3504-3508© 2011 Elsevier B.V.). X. Wang et al. disclose a multilayer structures with W-doped VO2 films deposited on an HfO2 layer and an Ag layer to achieve variable emittance based on the principle of reflection filter and semiconductor-to-metal transition of VO2 (see “Fabrication of VO2-based multilayer structure with variable emittance”, Key Laboratory of Inorganic Coating Materials, Shanghai Institute of Ceramics, Chinese Academy of Sciences, Shanghai 200050, China (Available online 26 Mar. 2015). A problem with these approaches is that the resulting panels (which all utilized unpatterned multilayer thin films) do not achieve very large contrast ratios (i.e., the α/∈ ratios achieved by these approaches is limited to 0.45-0.84).

What is needed is a radiative cooling panel for spacecraft that achieves a larger contrast for a/e ratio to minimize system-wide thermal transients. What is further needed for the radiative cooling panel to be lightweight and to self-modulate (self-adjust) its thermal emission and solar absorption properties in response to an external stimulus (i.e., either passively in response to a change in ambient temperature or other environmental condition, or actively in response to an applied electromagnetic signal). Moreover, what is further needed is a reliable mechanism for adjustably pre-setting the panel's self-modulating characteristics (e.g., by way of adjusting the transition temperature at which the panel switches between high thermal emission and low thermal emission states) in order to facilitate tailoring each panel to a particular spacecraft's operational needs.

### SUMMARY OF THE INVENTION

The present invention is directed to a radiative cooling panel for spacecraft that utilizes a dielectric layer disposed between a (lower) mirror layer and (upper) spaced-apart phase change islands to switch between a low thermal emission state (high α/∈ ratio) and high emission state (low ale ratio) to minimize system-wide thermal transients. The thermal emission at a targeted mid-IR wavelength is approximately equal to an associated blackbody spectrum peak wavelength corresponding to the operating temperature of the spacecraft. According to a first aspect, the phase change islands comprise a phase change (e.g., thermochromic) material that transitions between a dielectric state (first phase) at low temperatures and a metal state (second phase) at high temperatures. According to a second aspect, the phase change material islands are disposed on an upper surface of the dielectric layer in a two-dimensional grating pattern having a lattice constant value that is comparable to mid-IR wavelengths (i.e., with period between adjacent islands in the range of 2 to 10 μm). Note that the size of each phase change island is less important than the lattice constant value (periodic spacing) of the grating pattern, in a presently preferred embodiment the phase change islands are preferably formed with fill factor of approximately 50% (i.e., in the range of 20% and 80%). According to a third aspect, the dielectric layer and the phase change islands are cooperatively configured such that the panel emits minimal thermal radiation when the phase change material is in its first (i.e., dielectric state) phase, and such that the panel emits substantially larger amounts of thermal radiation when the phase change material is in its second (i.e., metal state) phase. Specifically, when the phase change material is in the first phase at low temperatures, similarities between the refractive indices of the low-loss dielectric state phase change material and the dielectric material of the dielectric layer minimizes coupling of thermal (mid-IR) radiation into guided modes of the dielectric layer, whereby the radiative cooling panel absorbs\emits zero or minimal amounts of thermal radiation (low emissivity mode). In contrast, when the phase change material transitions to its second phase at high temperatures, the metallic state of the phase change islands interacts with the dielectric layer in a way that produces substantially great coupling of mid-IR guided modes in the dielectric layer, thereby almost completely absorbing/emitting the mid-IR radiation (high emissivity mode). In addition, these guided resonances are “tuned” (i.e., their frequency is controlled) by the grating pattern of the phase change islands 130, and more particularly, by the lattice constant at which the islands are spaced, whereby the guided resonances achieve a peak resonance that approximately equals the targeted mid-IR peak wavelength (e.g., 8 μm). Accordingly, by incorporating the above-mentioned aspects and features, radiative cooling panels produced in accordance with the present inventors achieve α/∈ ratio contrast—between low emission and high emission states—greatly exceeding 0.39, thereby providing a significant improvement over all conventional approaches.

According to a presently preferred embodiment, the mirror layer of the radiative cooling panel is implemented using a reflective metal (e.g., a pure metal such as silver, aluminum or gold, or an alloy thereof) in order to provide both good solar reflection properties as well as good thermal conduction of heat energy.

According to another presently preferred embodiment, the dielectric layer of the radiative cooling panel is implemented using a low mid-IR loss dielectric material that exhibits a moderate refractive index in the mid-IR wavelength range (e.g., hafnium dioxide (HfO₂)). In a specific preferred embodiment, the dielectric layer has a thickness that is less than the targeted mid-IR peak wavelength (e.g., approximately 8 μm) divided by the refractive index of the dielectric material at the targeted operating temperature for the targeted nominal emission wavelength (for example, the refractive index of HfO₂ for 8 μm at 300K is approximately 1.75).

According to an aspect of the practical embodiment, the phase change islands of the radiative cooling panel are implemented using a thermochromic material (e.g., VO₂, V₂O₃, V₂O₅, V₆O₁₃ and TiₙO₂ₙ₊₁). An advantage provided by thermochromic-type phase change materials is that they passively self-modulates (self-adjusts) the thermal emission and absorption properties of the panel in response to changes in ambient temperature (e.g. sun-facing or space-facing). In particular, thermochromic materials are characterized by assuming one (e.g., dielectric state) phase when ambient temperatures are below the thermochromic material's transition temperature, and passively transforming (self-adjusting) into a second (e.g., metal state) phase when ambient temperatures rise above the transition temperature. Another advantage of using thin-film thermochromic material (e.g., VO₂, V₂O₃, V₂O₅, V₆O₁₃ or TiₙO₂ₙ₊₁) is that their transition temperature is adjustable by way of an optional dopant. Although thermochromic materials are presently preferred phase change materials for radiative cooling panels produced in accordance with the present invention due to their passive self-modulation in accordance to ambient temperature, other phase change materials may be utilize that either passively self-regulate (e.g., in response to environmental conditions other than temperature), or actively self-regulate (e.g., in response to an applied stimulus generated by a control system).

According to a presently preferred embodiment, the phase change islands utilized in radiative cooling panels produced in accordance with the present invention are preferably implemented using thin-film VO₂ structures having a thickness in the range of 20 nm and 100 nm. As set forth above, VO₂ has the beneficial characteristic of transitioning between a dielectric state (first phase) when subjected to ambient temperatures below its nominal transition temperature (i.e., approximately 66° C.) to a metal state (second phase) at ambient temperatures above its transition temperature. Moreover, VO₂ has the added beneficial characteristic of having a transition temperature that may be adjusted downward (e.g., into the range of 20° C. and 30° C.) by way of introducing a suitable dopant (e.g., tungsten) using known techniques during the associated thin-film formation process.

According to another aspect of the presently preferred embodiment, thin-film VO₂-based phase change islands doped with tungsten are formed on or embedded in the upper surface of a HfO₂ layer. Embedding the thin-film VO₂-based phase change islands provides panel with a presently preferred planar outer surface, but suitable performance is achievable by depositing and patterning the thin-film VO₂-based phase change islands on the upper surface of the HfO₂ layer.

According to alternative embodiments, one or more additional outer coating layers (e.g., a conductive material layer, a solar reflective material layer, and/or a protective material layer) may be formed over the phase change islands (i.e., over the upper surface of the HfO₂ layer). This optional outer layer may be added to increase robustness, surface conductivity, and/or to further increase solar reflectance, and may be implemented using indium tin oxide).

According to an exemplary practical embodiment of the present invention, a self-adjusting passive radiative cooling panel includes a reflective metal (e.g., a pure metal such as silver (Ag) or an alloy thereof) mirror layer, a dielectric layer implemented using a low mid-IR loss dielectric material (e.g., hafnium dioxide (HfO₂)), and an array of phase change islands implemented using thin-film thermochromic material (e.g., VO₂, V₂O₃, V₂O₅, V₆O₁₃ or TiₙO₂ₙ₊₁), with the thickness of the dielectric layer and/or the lattice grating (spacing) of the phase change islands being set such that, when the thin-film thermochromic material is in its metal state, the array of phase change islands cause guided modes in the dielectric layer which results in a peak resonance that is approximately equal to a target mid-IR wavelength associated with the peak wavelength of the blackbody spectrum corresponding to the operating temperature of the spacecraft.

### BRIEF DESCRIPTION OF THE DRAWINGS

These and other features, aspects and advantages of the present invention will become better understood with regard to the following description, appended claims, and accompanying drawings, where:

FIG. 1 is a perspective top view showing a radiative cooling panel according to a simplified embodiment of the present invention;

FIG. 2 is an exploded perspective view showing the radiative cooling panel of FIG. 1;

FIGS. 3(A) and 3(B) are simplified cross-sectional side views depicting the radiative cooling panel of FIG. 1 during operation;

FIGS. 4(A), 4(B), 4(C) and 4(D) are a graphs respectively depicting modeled emission spectrums for exemplary radiative cooling panels;

FIG. 5 is perspective top view showing a radiative cooling panel according to an alternative simplified embodiment of the present invention; and

FIG. 6 is perspective top view showing a radiative cooling panel according to another alternative simplified embodiment of the present invention.

### DETAILED DESCRIPTION OF THE DRAWINGS

The present invention relates to improved passive cooling panels for spacecraft. The following description is presented to enable one of ordinary skill in the art to make and use the invention as provided in the context of a particular application and its requirements. As used herein, directional terms such as “upper”, “top”, “lower”, and “bottom” are intended to provide relative positions for purposes of description, and are not intended to designate an absolute frame of reference. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

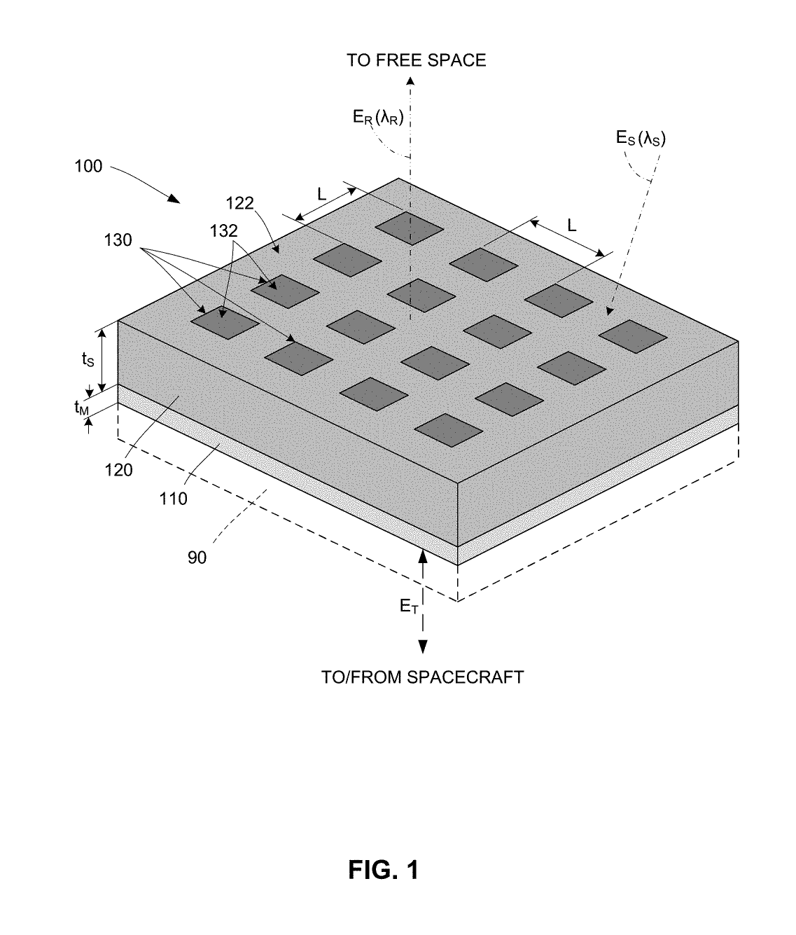

FIG. 1 depicts a simplified radiative cooling panel 100 of the present invention. In operation, radiative cooling panel 100 is physically mounted on and operably thermally coupled to an underlying support surface 90 (e.g., an outer surface or other structure through which heat energy E_{T} is operably transmitted to or from a spacecraft), and generally functions to selectively emit thermal radiation E_{R} having a peak mid-IR wavelength λ_{R} that is approximately equal to an associated blackbody spectrum peak wavelength λ_{P} corresponding to an anticipated operating ambient temperature in which panel 100 is expected to operate. For example, as indicated in FIG. 1, when a host spacecraft is deployed in sunlight, radiative cooling panel 100 receives solar radiation E_{S} having normal solar radiation wavelengths λ_{S}(i.e., having a peak radiation level centered around 550 nm), which generally produces higher ambient operating temperatures than when the spacecraft is deployed out of direct sunlight.

For purposes of explaining associated details, panel 100 is not drawn to scale in the associated figures, and it is understood that actual panels would be much larger than that shown in the figures.

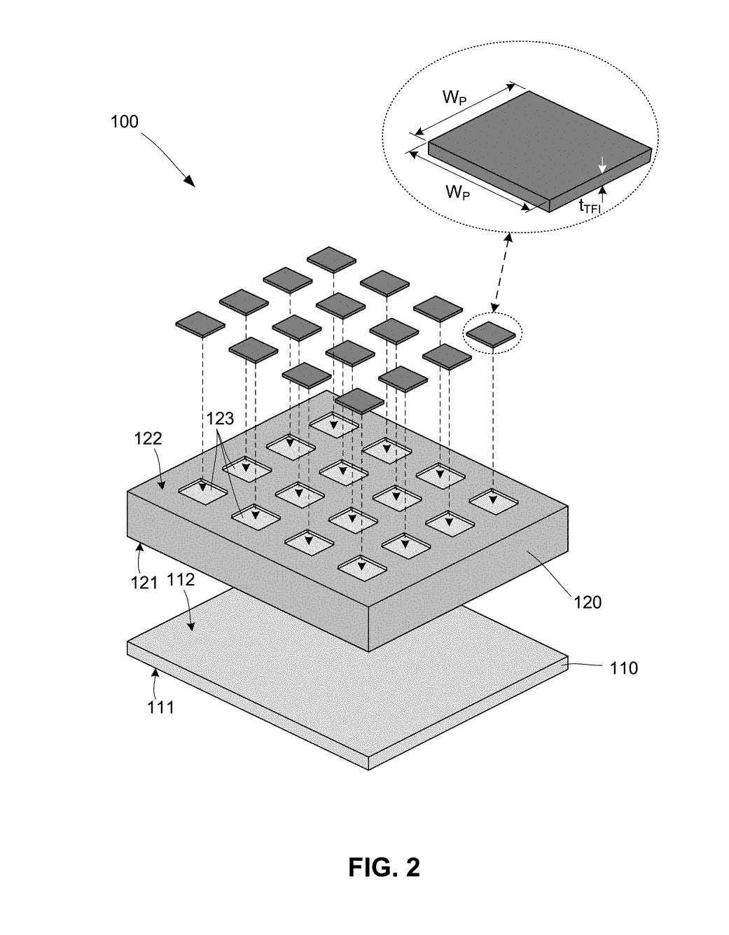

FIGS. 1 and 2 depict exemplary radiative cooling panel 100 in assembled and exploded views, respectively, and show that panel 100 essentially comprises a three-layer structure including a continuous bottom flat mirror layer 110, an intermediate planar dielectric layer 120, and an upper layer nominally defined by a patterned array of spaced-apart phase change islands 130. As indicated in FIG. 1, in practical applications mirror layer 110 is physically mounted on underlying support surface 90. As depicted in FIG. 2, dielectric layer 120 is disposed directly onto an upper surface 112 of mirror layer 110, and phase change islands 130 are embedded into an upper surface 122 of dielectric layer 120 such that uppermost surfaces 132 of phase change islands 130 are co-planar with upper surface 122 (i.e., such that panel 100 has a planar outer surface).

According to an aspect of the invention, mirror layer 110 includes a continuous (sheet-like) film comprising a material exhibiting total or near total reflectance of incident solar radiation E_{S}. In a presently preferred embodiment, mirror layer 110 comprises a reflective metal (e.g., a pure metal such as silver, aluminum or gold, or an alloy thereof) having a suitable thickness t_{M} (e.g., 200 nm), whereby mirror layer 110 exhibits both good solar reflection properties as well as good thermal conduction of heat energy E_{T} to/from underlying support surface 90. Suitable metal films are fabricated, for example, using known integrated circuit fabrication processes (e.g., by way of sputter deposition of metal).

Referring to FIG. 1, dielectric layer 120 is preferably implemented using a low-IR loss dielectric material that exhibits a moderate refractive index in the mid-IR range (i.e., 7 to 13 μm), and is formed with a nominal thickness t_{S} that is smaller than a targeted nominal emission wavelength (e.g., 8 μm) divided by the refractive index n of the dielectric material. As used herein, a low loss dielectric material is a dielectric material having a magnetic/electric loss tangent value of 0.1 or lower, and “exhibiting a moderate refractive index in the mid-IR range” is intended to mean a refractive index value in the range of 1.5 and 3. In a presently preferred embodiment, dielectric layer 120 is implemented using Hafnium Dioxide (HfO₂) having a thickness t_{S} that that facilitates the generation of guided resonances having target mid-IR peak wavelengths in the manner described below. To facilitate these resonances, the HfO₂ layer is formed with a nominal thickness t_{S} that is less that the target mid-IR peak wavelengths divided by the refractive index of the dielectric material (utilized to implement dielectric layer 120 at the spacecraft's anticipated operating ambient temperature and the target mid-IR wavelength, e.g., 800 nm). Although HfO₂ having a thickness—determined by one of the above methods and more accurately by full-wave electromagnetic simulations—is currently believed to optimize the optical characteristics of panel 100, other dielectric materials and other dielectric thicknesses may be utilized.

Referring again to FIG. 1, spaced-apart phase change islands 130 are disposed on upper surface 122 of dielectric layer 120 and arranged in an array pattern having a lattice constant L that facilitates the generation of guided resonances in dielectric layer 120 having a peak resonance wavelength that is approximately equal to the target mid-IR wavelength. For most practical embodiments, utilizing the materials described herein, lattice constant L is in the range of 2 to 10 microns. Referring briefly to FIG. 2, note that the size (i.e., area defined by width dimensions W_{P}) of each phase change island 130 is less important than lattice constant distance L, which defines the periodic spacing of islands 130 in the grating pattern, and in a presently preferred embodiment phase change islands 130 are preferably formed with areas that produce a fill factor (i.e., area covered by islands 130 divided by exposed dielectric layer surface 122) of approximately 50% (i.e., in the range of 20% and 80%).

According to an aspect of the invention, phase change islands 130 comprise a thermochromic (phase change) material (e.g., VO₂, V₂O₃, V₂O₅, V₆O₁₃ and TiₙO₂ₙ₊₁) that transitions between a dielectric state (first phase) and a metal state (second phase) in response to an external stimulus (e.g., in response to a change in ambient temperature). That is, these thermochromic materials are characterized by a transition temperature, and change between the metal and dielectric states when heated above or cooled below the transition temperature.

As explained below, by selecting a thermochromic material whose transition temperature coincides, e.g., with an average spacecraft system operating temperature, the dielectric state at ambient temperatures below the transition temperature, phase change islands 130 effectively function to “turn off” thermal radiation emissions by way of decreasing or preventing guided modes in the dielectric material, and by entering the metal state at high temperatures, phase change islands effectively function to “turn on” thermal radiation emissions by way of exciting guided modes in the dielectric layer. Moreover, by forming phase change islands 130 at a lattice constant spacing L according to the methods described herein, phase change islands further function to promote the generation of guided resonances in dielectric layer 120 at or near peak blackbody emission frequencies that maximize cooling efficiency at a given operating temperature.

Referring to FIG. 2, according to a presently preferred embodiment, phase change islands 130 are implemented using thin-film Vanadium Dioxide (VO₂) structures having a thickness t_{TFI} in the range of 20 nm and 100 nm. As set forth above, VO₂ has the beneficial characteristic of transitioning between a dielectric state (first phase) when subjected to ambient temperatures below its nominal transition temperature (i.e., approximately 66° C.) to a metal state (second phase) at ambient temperatures above its transition temperature. Moreover, VO₂ has the added beneficial characteristic of having a transition temperature that can be adjusted by way of adding a suitable dopant during the thin-film formation process. For example, the transition temperature of VO₂ is adjusted downward (e.g., into the range of 20° C. and 30° C.) by way of a tungsten dopant.

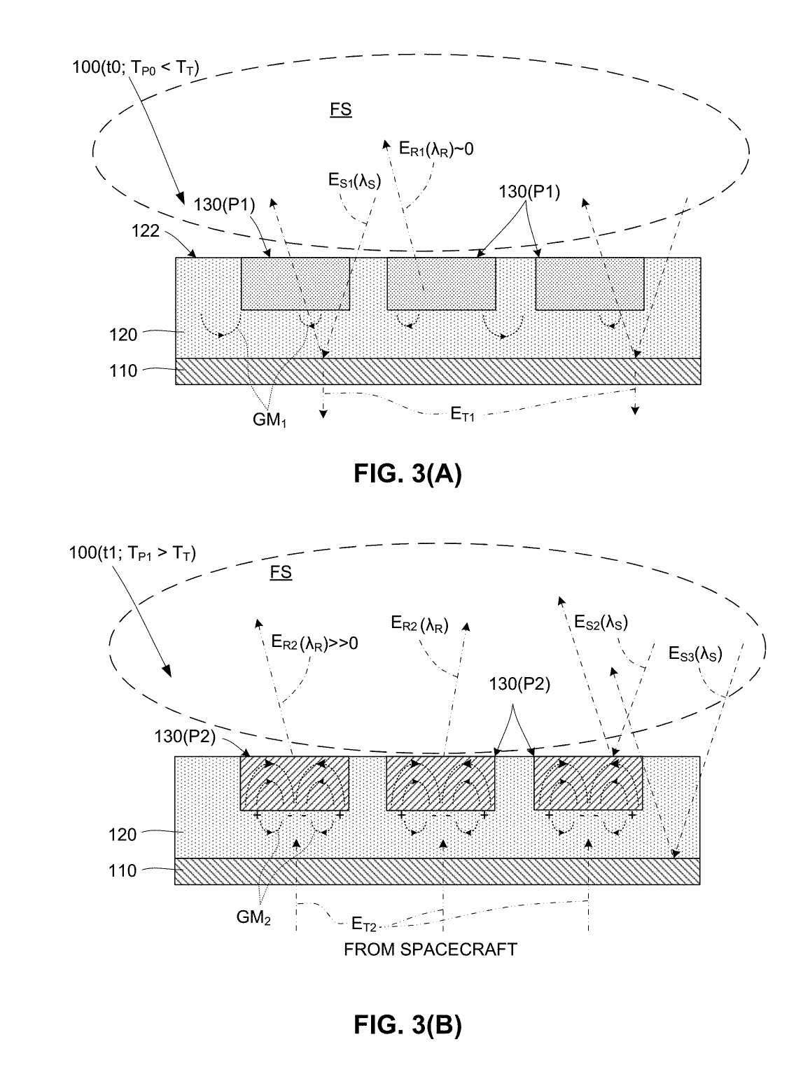

FIGS. 3(A) and 3(B) respectively depict panel 100 at two different time periods associated with two different ambient temperatures. Specifically, FIG. 3(A) depicts panel 100 at a time t0 when subjected to an ambient temperature T_{P0} that is below transition temperature T_{T} of phase change islands 130, whereby panel 100(t0) is in a non-emitting mode. In contrast, FIG. 3(B) depicts panel 100 at a time t1 when subjected to an ambient temperature T_{P1} that is above transition temperature T_{T}, whereby panel 100(t1) in a thermal radiation emission (cooling) mode.

Referring to FIG. 3(A), when phase change islands are at ambient temperature T_{P0} below transition temperature T_{T}(i.e., T_{P0}<T_{T}), phase change islands 130 are in the dielectric state (i.e., first phase, indicated by “130(P1)” in FIG. 3(A)). When VO₂ is in its dielectric state, its refractive index nearly matches that of HfO₂, making the structure weakly absorbing, preventing generation of guided modes GM₁ in dielectric layer 120, whereby panel 100 emits a minimal amount of thermal radiation (i.e., E_{R1}(λ_{2R})˜0). Note also that almost all incident solar radiation E_{S1} passes through the dielectric material and is reflected by mirror layer 110. By Kirchhoff's law, absorptivity is equal to emissivity, so the emission is very low.

FIG. 3(B) shows panel 100 when phase change islands 130 are at ambient temperature T_{P1} above transition temperature T_{T} (i.e., T_{P0}>T_{T}), and therefore transitioned to their metal state (i.e., second phase, indicated by “130(P2)” in FIG. 3(B)). In this state, the metal state of phase change islands 130 interacts with dielectric layer 120 in a way that produces substantial coupling of mid-IR guided mode resonances GM₂ in dielectric layer 120. In addition, these guided resonances are “tuned” (i.e., their frequency is controlled) by the grating pattern of the phase change islands 130, and more particularly, by lattice constant L at which islands 130 are spaced, whereby the guided resonances achieve a peak resonance that approximately equals the targeted mid-IR peak wavelength (e.g., 8 μm). The guided modes in the dielectric layer are coupled to free space FS via the grating pattern utilized to form phase change islands 130. Accordingly, panel 100(t1) is in a thermal radiation emission mode that effectively draws thermal heat E_{T2} from underlying structures (not shown), and converts the thermal heat to thermal radiation E_{R2} that is emitted into free space FS.

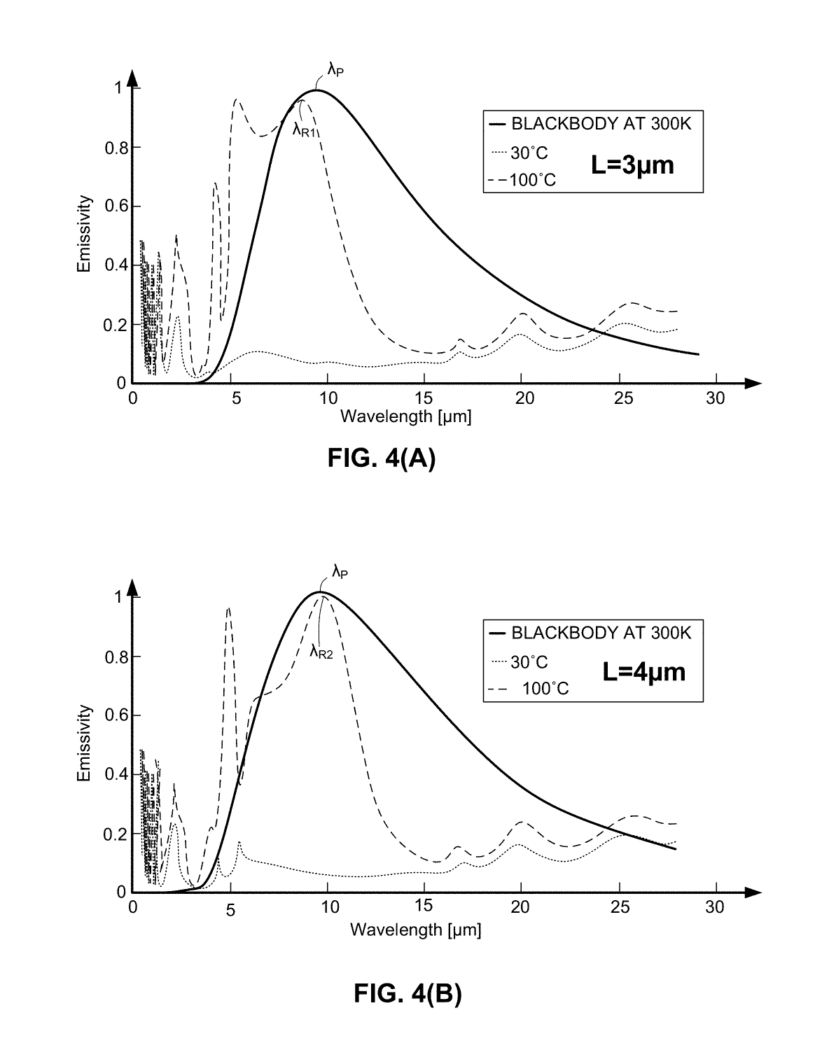

FIGS. 4(A) to 4(D) are graphs showing modeled optical response characteristics for radiative cooling panels generated in accordance with the specific embodiments described above, where the respective graphs are modeled for different lattice constants L of 3 μm (FIG. 4(A)), 4 μm (FIG. 4(B)), 5 μm (FIG. 4(C)) and 6 μm (FIG. 4(D)) using a suitable dielectric thickness. Note that emissions are modeled for a temperature above the phase change material's transition temperature (i.e., 100° C.) to illustrate panel operating characteristics when in the emission (cooling) mode (i.e., as described above with reference to FIG. 3(B)), and for a temperature below the phase change material's transition temperature (i.e., 30° C.) to illustrate panel operating characteristics when in the non-emitting mode (i.e., as described above with reference to FIG. 3(A)). As indicated in these graphs, the respective peak mid-IR emission wavelengths λ_{R1} to λ_{R4} can be tuned and positioned at a desired emission wavelength by changing the lattice constant L. FIGS. 4(A) to 4(D) also demonstrate that panel emissions can be modulated from around 10% at low temperatures to about 90% at high temperatures.

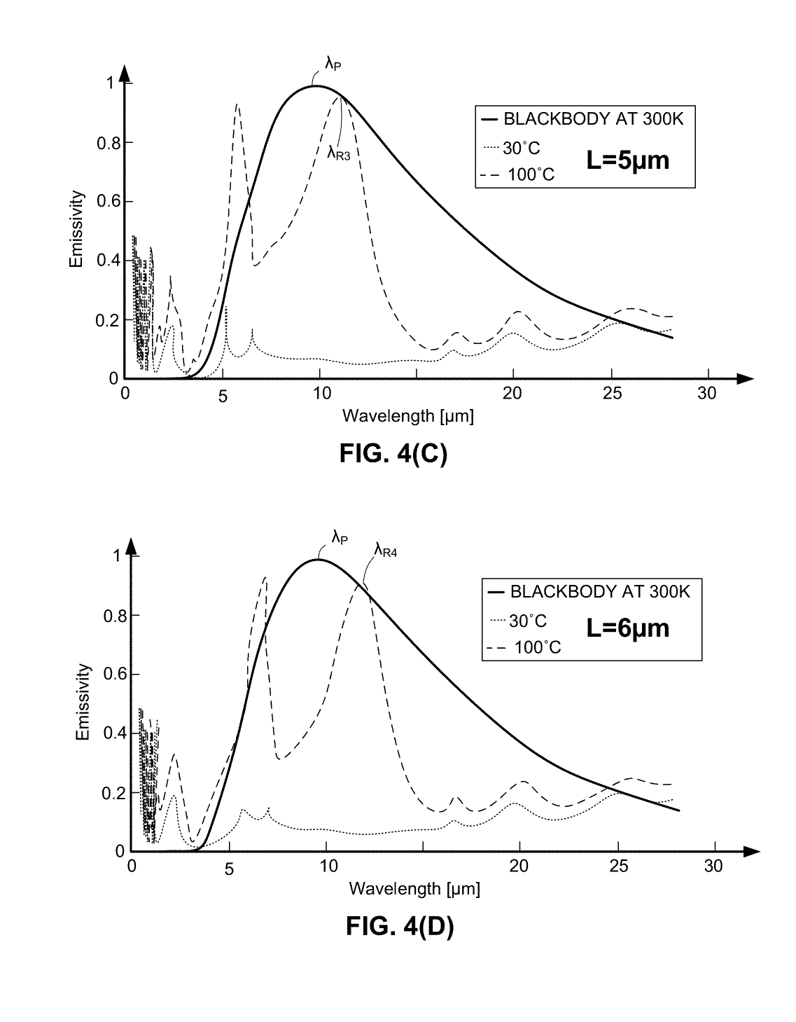

FIG. 5 is perspective top view showing a radiative cooling panel 100A according to an alternative embodiment of the present invention in which phase change islands (e.g., thin-film VO₂ pads) 130A are patterned on upper surface 122A of dielectric layer 120A (i.e., instead of embedded inside the dielectric material forming the dielectric layer, as described above with reference to FIGS. 1 and 2). As mentioned above, each thin-film VO₂ structure 130B optionally includes a dopant (e.g., Tungsten) to adjust the associated transition temperature. Other structures of panel 100A are the same as those mentioned above.

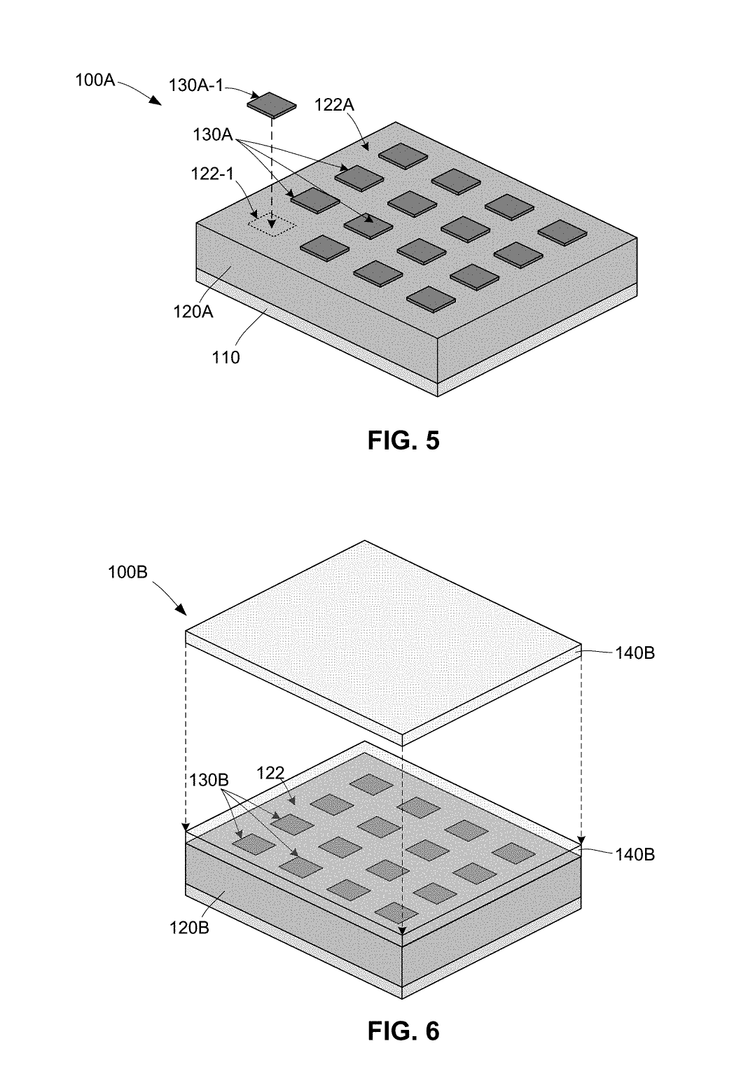

In accordance with another exemplary alternative embodiment shown in FIG. 6, a radiative cooling panel 100B includes an additional (outer) layer 140B disposed over phase change islands 130B and exposed portions of upper surface 122B of dielectric layer 120B. Outer layer 140B (e.g., indium tin oxide) forms one or more of a conductive material layer, a solar reflective material layer and a protective material layer that provide added robustness, higher surface conductivity, and/or further increase solar reflectance of panel 100b. A sufficiently thin outer layer of this type will either not affect the optical performance, or the structural parameters can be adjusted to compensate for the presence of such a coating. Other structures of panel 100B are the same as those mentioned above.

Although the present invention has been described with respect to an exemplary specific embodiment, it will be clear to those skilled in the art that the inventive features of the present invention are applicable to other embodiments as well, all of which are intended to fall within the scope of the present invention. For example, mirror layer 110 (FIG. 1) may be implemented using a stack of alternating non-metal materials, but a reflective metal is preferred for performance and cost purposes. In addition, dielectric layer 120 may be implemented using dielectric materials other than HfO₂ (e.g., Potassium Bromide (KBr)), but is preferably formed using a low mid-IR loss (i.e., having a magnetic/electric loss tangent value of 0.1 or lower). In addition, phase change islands 130 may be implemented using thermochromic materials other than those specified above, or using other types of phase change materials controlled by external stimuli other than ambient temperature (e.g., passively in response to another environmental condition such as ambient light, or actively in response to a stimulus generated by a control circuit). In addition, although the phase change islands are depicted in the figures as square-shaped pads, the phase change islands may have any operable shape (e.g., rectangle or circle).

1. A radiative cooling panel configured to selectively emit thermal radiation having a peak mid-IR wavelength approximately equal to an associated blackbody spectrum peak wavelength corresponding to an anticipated operating temperature of said panel, said panel comprising:
a mirror layer;
a dielectric layer disposed over an upper surface of the mirror layer and consisting essentially of a low-loss dielectric material; and
a plurality of phase change islands disposed on an upper surface of the dielectric layer and arranged in an array pattern having a lattice constant in the range of 2 to 10 μm,
wherein said plurality of phase change islands comprise a phase change material that transitions between a first phase and a second phase in response to an external stimulus, and
wherein dielectric layer and said plurality of phase change islands are operably configured such that:
when said phase change material is in said first phase, said phase change material decreases coupling of guided modes in said dielectric layer, whereby said radiative cooling panel emits a minimal amount of said thermal radiation, and
when said phase change material is in said second phase, said phase change material increases coupling of guided modes in the said dielectric layer, and causes said guided modes to achieve a peak absorption/emission resonance approximately equal to said peak mid-IR wavelength, whereby said radiative cooling panel emits relatively large amounts of said thermal radiation.

2. The radiative cooling panel according to claim 1, wherein said plurality of phase change islands occupy a fill factor portion of a total area of said upper surface of said dielectric layer, said fill factor portion being in the range of 20% and 80%.

3. The radiative cooling panel according to claim 1, wherein said mirror layer comprises at least one of silver, aluminum and gold.

4. The radiative cooling panel according to claim 1, wherein said dielectric layer comprises one of Hafnium Dioxide (HfO₂) and Potassium Bromide (KBr).

5. The radiative cooling panel according to claim 1, wherein said dielectric layer has a thickness smaller than said target nominal wavelength divided by a refractive index of said dielectric material at said anticipated operating ambient temperature and said peak mid-IR wavelength.

6. The radiative cooling panel according to claim 1, wherein said phase change material comprises a thermochromic material having a transition temperature, and wherein said external stimulus comprises an ambient temperature of said radiative cooling panel, whereby said thermochromic material transitions from said second phase to said first phase when said ambient temperature decreases from above to below said transition temperature, and said thermochromic material transitions from said first phase to said second phase when said ambient temperature increases from below to above said transition temperature.

7. The radiative cooling panel according to claim 6, wherein said thermochromic material comprises at least one of VO₂, V₂O₃, V₂O₅, V₆O₁₃ and TiₙO₂ₙ₊₁.

8. The radiative cooling panel according to claim 1, wherein each said phase change island comprises a thin-film structure comprising Vanadium Dioxide (VO₂) and having a thickness in the range of 20 nm and 100 nm.

9. The radiative cooling panel according to claim 8, wherein each said thin-film structure further comprises a dopant incorporated into said VO₂ such that said transition temperature of said doped VO₂ is in the range of 20° C. and 30° C.

10. The radiative cooling panel according to claim 1,
wherein said dielectric layer comprises Hafnium Dioxide (HfO₂), and
wherein each said phase change island comprises a thin-film Vanadium Dioxide (VO₂) structure that is either embedded into or disposed on top of said upper surface of said dielectric layer.

11. The radiative cooling panel according to claim 10, wherein each said thin-film VO₂ structure comprises Vanadium Dioxide (VO₂) doped with Tungsten (W).

12. The radiative cooling panel according to claim 1, further comprising one or more outer layers disposed over the plurality of phase change islands, said one or more outer layers comprising at least one of a conductive material layer, a solar reflective material layer and a protective material layer.

13. A self-adjusting passive radiative cooling panel configured to generate relatively low thermal radiation emissions when subjected to ambient temperatures below a predetermined median operating temperature, and to generate substantially higher thermal radiation emissions having a mid-IR peak wavelength when subjected to ambient temperatures above said predetermined median operating temperature, said panel comprising:
a mirror layer comprising a reflective metal;
a dielectric layer disposed over an upper surface of the mirror layer; and
a plurality of spaced-apart phase change islands disposed in an array pattern having a lattice constant on an upper surface of the dielectric layer,
wherein said dielectric layer comprises a low mid-IR loss dielectric material having a thickness that is less than said mid-IR peak wavelength,
wherein each island of said plurality of phase change islands includes a thin-film structure consisting of one or more thermochromic materials configured to change from a dielectric state to a metal state when said ambient temperatures increases from below said predetermined median operating temperature to above said predetermined median operating temperature, and
wherein said lattice constant of said plurality of phase change islands is set such that, when said thermochromic material is in a metal state, said plurality of phase change islands cause guided modes is said dielectric layer to achieve a peak resonance approximately at said mid-IR peak wavelength.

14. The radiative cooling panel according to claim 13, wherein said plurality of phase change islands occupy a fill factor portion of a total area of said upper surface of said dielectric layer, said fill factor portion being in the range of 20% and 80%.

15. The radiative cooling panel according to claim 13, wherein said mirror layer comprises at least one of silver, aluminum and gold.

16. The radiative cooling panel according to claim 13, wherein said dielectric layer comprises one of Hafnium Dioxide (HfO₂) and Potassium Bromide (KBr).

17. The radiative cooling panel according to claim 13, wherein the thin-film structure of each said phase change island has a thickness in the range of 20 nm and 100 nm.

18. The radiative cooling panel according to claim 17, wherein each said thin-film structure further comprises a dopant incorporated into said thermochromic material such that said doped thermochromic material has a transition temperature in the range of 20° C. and 30° C.

19. The radiative cooling panel according to claim 13, further comprising one or more outer layers disposed over the plurality of phase change islands, said one or more outer layers comprising at least one of a conductive material layer, a solar reflective material layer and a protective material layer.

20. A self-adjusting passive radiative cooling panel comprising:
a mirror layer;
a dielectric layer disposed over an upper surface of the mirror layer and comprising Hafnium Dioxide (HfO₂) having a nominal dielectric thickness;
a plurality of spaced-apart phase change islands disposed on an upper surface of the dielectric layer and arranged in an array pattern having a lattice constant,
wherein each island of said plurality of phase change islands consists of a thin-film structure comprising a thermochromic material selected from the group including VO₂, V₂O₃, V₂O₅, V₆O₁₃ and TiₙO₂ₙ₊₁,
wherein said nominal dielectric thickness of said dielectric layer and said lattice constant of said plurality of phase change islands are configured such that, when said thermochromic material is in a metal state, said plurality of phase change islands cause guided modes is said dielectric layer to achieve resonance at a peak mid-IR wavelength.
